(19) United States
(12) Patent Application Publication
(10) Pub. No.: US 2002/0018286 A1
(43) Pub. Date: Feb. 14, 2002

(54) Method for embodying non-reciprocal optical wavelength filter and the apparatus

(76) Inventors: Chang Hee Lee, Taejon (KR); Tae Won Oh, Taegu (KR); Jeong Hun Shin, Taegu (KR); Yun Hee Cho, Seoul (KR); Hyun Deok Kim, Taegu (KR)

Correspondence Address: BACON & THOMAS, PLLC, 4th Floor, 625 Slaters Lane, Alexandria, VA, 22314-1176, US

(21) Appl. No.: 09/726,540

(22) Filed: Dec. 1, 2000

(30) Foreign Application Priority Data
Aug. 4, 2000 (KR) 45367

(51) Int. Cl. H01S 3/00

(52) U.S. Cl. 359/337.2

(57) ABSTRACT

The present invention relates to an apparatus and a method for a Non-Reciprocal Optical Wavelength Filter (NRWF) suitable for bidirectional optical transmissions, communications, and amplifiers.

The NRWF of the present invention is composed of (1) a Reciprocal Rotator (RR) rotating the polarization state of the light reciprocally, (2) a non-reciprocal Faraday Rotator (FR) rotating the polarization state non-reciprocally according to the propagating direction, (3) two polarization beam splitters, BC1 and BC2, splitting an unpolarized wave into two orthogonally polarized waves, or combining the two orthogonally polarized waves, and (4) a Wavelength Dependent Polarization Converter (WDPC) changing the polarization state according to the wavelength of light. Accordingly, the NRWF has periodic transfer spectra, and the peaks of the transfer spectrum from Port 1 to Port 2 are located between those of the transfer spectrum form Port 2 to Port 1.

Therefore, the NRWF of the invention suppresses multiple reflections in wavelength interleaved bidirectional transmissions. The optical amplifiers with the NRWF of the invention are useful for long-haul bidirectional systems and networks.

### BACKGROUND OF THE INVENTION

1. Field of the Invention

The present invention relates to a Non-Reciprocal Optical Wavelength Filter (NRWF) suitable for bidirectional optical transmissions, communications, and amplifiers. More particularly, the invention relates to a NRWF with different transfer spectra with respect to the propagating direction of light and also relates to its applications.

2. Description of the Related Art

The bidirectional Wavelength Division Multiplexing (WDM) optical transmission systems can be classified into an optical band split type and an optical wavelength interleaved type according to the method of wavelength assignment. In the case of the optical band split type, the transmission bands for each direction are separated by Optical Band Pass Filters (OBPFs), and the wavelengths of optical signals propagating in same direction are assigned adjacently in the same band. On the other hand, in wavelength interleaved type, the wavelengths of the optical signals propagating in each direction is assigned between those of the optical signals propagating in opposite direction. The wavelength interleaved type does not need a guard band which is required to separated two bands in band split type, and reduce the nonlinear effects between the adjacent channels.

Since the use of optical isolators is restricted in bidirectional optical transmissions, severe system degradations are caused by multiple reflections due to Rayleigh back scattering and optical reflections. Especially, when an optical amplifier is used to compensate the optical loss from fibers or other optical devices, the optical amplifier magnifies the reflected light as well, then the multiple reflections become more serious. Therefore, it is necessary to suppress the multiple reflections.

FIG. 1a and FIG. 1b are block circuit diagrams for conventional frequency dependent optical isolators. They show the structure of frequency dependent optical isolators that suppress the reflected light. The figures come from U.S. Pat. No. 5,280,549. As shown in FIG. 1a, a frequency dependent optical isolator consists of two optical isolators (OI1, OI2) and two Optical Band Pass Filters (OBPF1, OBPF2). Another frequency dependent optical isolator is shown in FIG. 1b. It has one optical circulator and two Optical Band Rejection Filters (OBRFs). These inventions are suitable for the optical band split method.

For wavelength interleaved bidirectional transmissions, the OBPFs shown in FIG. 1a should be replaced with optical filters with periodic transfer characteristics. However, these method require many optical devices, and has a demerit of high costs. Accordingly, a simpler and more effective method for wavelength interleaved bidirectional transmissions is required.

### SUMMARY OF THE INVENTION

It is an object of the present invention to provide a NRWF, which has the different periodic wavelength characteristics according to the propagating direction. The present invention can solve the above mentioned problems.

In accordance with an aspect of the invention there are provided a method and an apparatus for the NRWF, as a two-port filter with different transfer spectra according to the propagating direction of light. The NRWF has periodic transfer spectra. The peaks of the transfer spectrum from Port 1 to Port 2 are located between those of the transfer spectrum from Port 2 to Port 1.

When the transmitted light from Port 1 to Port 2 without attenuation is reflected by fibers and optical devices and enters Port 2, the reflected light is attenuated by the filter. Similarly, when the transmitted light from Port 2 to Port 1 is reflected, the reflected light is attenuated.

In accordance with another aspect of the invention there is provided a bidirectional optical amplifier having Erbium Doped Fibers (EDFs), the NRWFs of the invention, and an Inter-Stage Component (ISC).

### BRIEF DESCRIPTION OF THE DRAWINGS

Exemplary embodiments of the present invention will be described in conjunction with the drawings in which:

FIG. 1a and FIG. 1b are block circuit diagrams for conventional frequency dependent optical isolators;

FIG. 2 shows the characteristic function of the Non-Reciprocal Optical Wavelength Filter (NRWF) according to the present invention;

FIG. 3 shows the characteristic function of the Wavelength Dependent Polarization Converter (WDPC) according to the present invention;

FIG. 4 is a schematic diagram for the Non-Reciprocal Optical Wavelength Filter (NRWF) according to the present invention;

FIG. 5 shows the propagation paths and the polarization states of transmitted light from Port 1 to Port 2 of FIG. 4;

FIG. 6 shows the propagation paths and the polarization states of attenuated light from Port 1 to Port 2 of FIG. 4;

FIG. 7 shows the propagation paths and the polarization states of transmitted light from Port 2 to Port 1 of FIG. 4;

FIG. 8 shows the propagation paths and the polarization states of attenuated light from Port 2 to Port 1 of FIG. 4; and

FIG. 9 is a schematic diagram for the bidirectional optical amplifier using the Non-Reciprocal Optical Wavelength Filter (NRWF) according to the present invention.

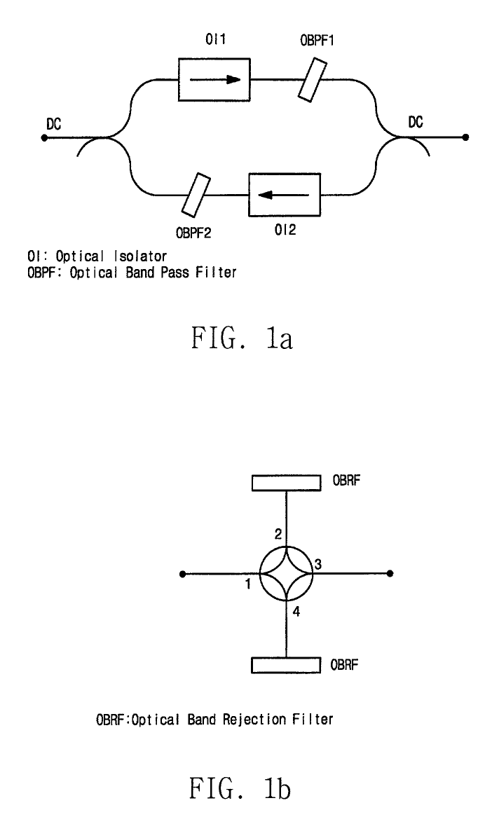

<Explanations for Main Symbols in the Drawings>

OI1, OI2: Optical Isolator,

WDPC: Wavelength Dependent Polarization Converter,

OBPF: Optical Band Pass Filter,

OBRF: Optical Band Rejection Filter,

BC1, BC2: Birefringent Crystal,

FR: Faraday Rotator, ISC: Inter-Stage Component,

RR: Reciprocal Rotator,

EDF1, EDF2: Erbium Doped Fiber

NRWF1, NRWF2: Non-Reciprocal Optical Wavelength Filter

### DETAILED DESCRIPTION OF THE EMBODIMENTS

The present invention will be better understood with regard to the following description, appended claims, and accompanying figures.

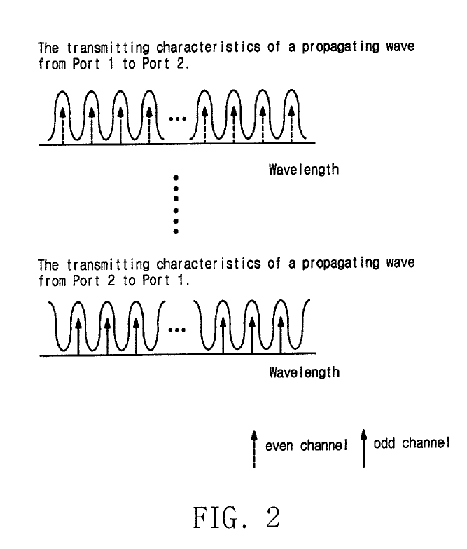

FIG. 2 shows the transfer function of the Non-Reciprocal Optical Wavelength Filter (NRWF) according to the present invention. The NRWF of the invention is a 2-port optical device, and has periodic transfer spectrum according to the propagating direction. The peaks of the transfer spectrum from Port 1 to Port 2 are located between those from port 2 to port 1. In other words, when the transmitted light from Port 1 to Port 2 without attenuation are reflected by fibers and optical devices, the reflected light is attenuated as it propagates from port 2 to Port 1. Similarly, when the transmitted light from Port 2 to Port 1 is reflected, the reflected light is attenuated as it propagates from port 1 to Port 2. Therefore, the NRWF of the invention suppresses multiple reflections. The NRWF of the invention can be easily used in a bidirectional optical amplifier since it has simple structure and can be made with a low cost.

The NRWF of the invention is based on (1) non-reciprocal polarization rotation by a Faraday Rotator (FR) and (2) wavelength-dependent polarization rotation by a Wavelength Dependent Polarization Converter (WDPC).

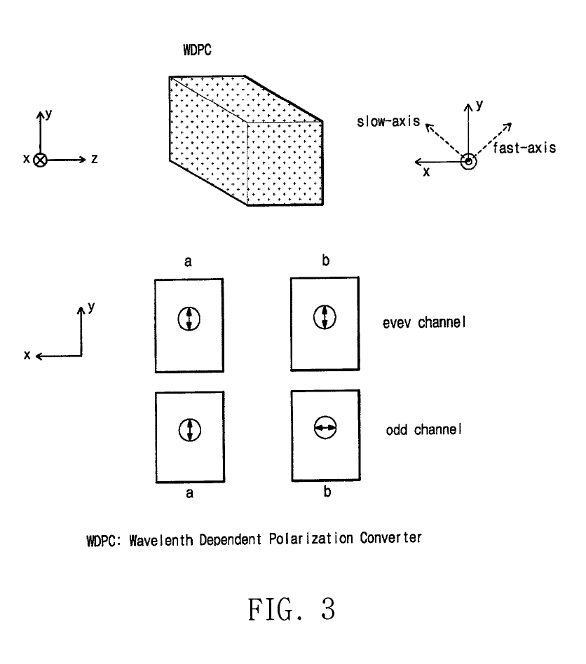

FIG. 3 shows the characteristic function of the Wavelength Dependent Polarization Converter (WDPC) according to the present invention. The WDPC is an anisotropic crystal with large birefringence as shown in FIG. 3. The incident angle of the wave to the WDPC becomes 45° with respect to the crystal axis. The WDPC of the invention periodically changes the polarization state of light according to the wavelength.

For the convenience, if light passes through the WDPC without the change of the polarization state, light will be called even-channel signal. If the WDPC acts as a half wave plate, and the polarization state of light is rotated by 90°, light is called Odd-channel signal.

The odd-channel wavelength (λpo) and the even-channel wavelength (λpe) are determined by refractive indexes and the length (L) of the anisotropic crystal used for the WDPC:

λpo=2(ns−nf)L/m, where m=1, 3, 5, . . . (EQUATION 1)

λpe=2(ns−nf)L/m, where m=2, 4, 6, . . . (EQUATION 2)

Here, ns and nf are refractive indexes for crystal axes.

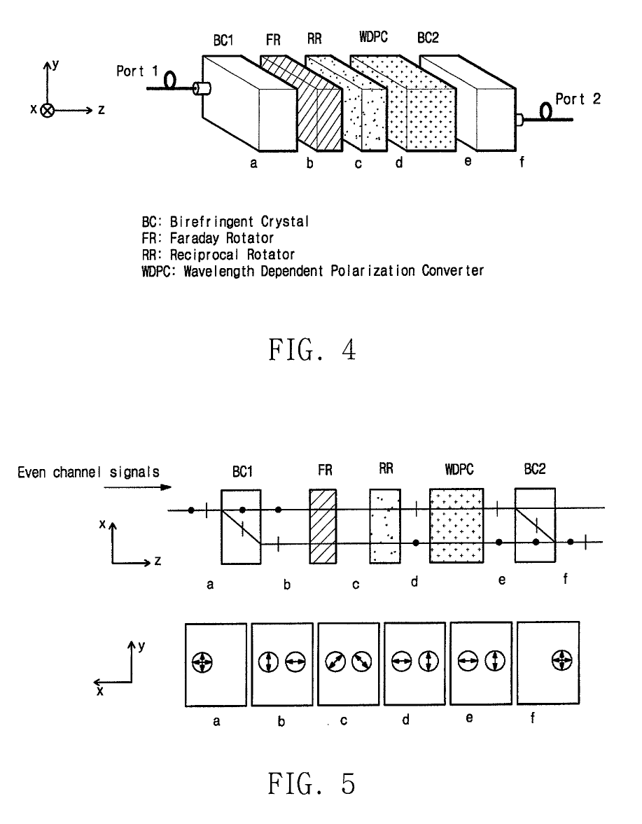

FIG. 4 is a schematic diagram for the Non-Reciprocal Optical Wavelength Filter (NRWF) according to the present invention. As shown in FIG. 4, the NRWF consists of a Reciprocal Rotator (RR), a FR, a WDPC, and two polarization bean splitters (PBSs). The NRWF can be embodied with several configurations. Each element has an anti-reflection coating to eliminate optical reflections on the surfaces.

Two polarization beam splitters, BC1 and BC2, split unpolarized light into two orthogonally polarized lights, or combine two orthogonally polarized lights. A RR rotates the polarization state of light by +45° for any propagation direction. However, a FR, non-reciprocal rotator, rotates the polarization state of light by +45° when light propagates along +Z direction, and it rotates the polarization state by −45° when light propagates along −Z direction. Therefore, when light passes through a FR and a RR, the polarization state of light is rotated by +90° if light propagate along +Z direction, and the polarization state is preserved if the light propagates along −Z direction.

FIG. 5 shows the propagation paths and the polarization states of a transmitted light from Port 1 to Port 2 of FIG. 4. The even-channel signal is incident to Port 1 of the NRWF. After the incident light is collimated by the lens, it is separated into an ordinary wave and an extraordinary wave by the first polarization beam splitter, BC1. Two orthogonally polarized lights are rotated by +90° after they pass through the FR and the RR, and the polarization state is preserved by the WDPC. Two orthogonally polarized light are combined by the second polarization beam splitter, BC2, and are focused on Port 2.

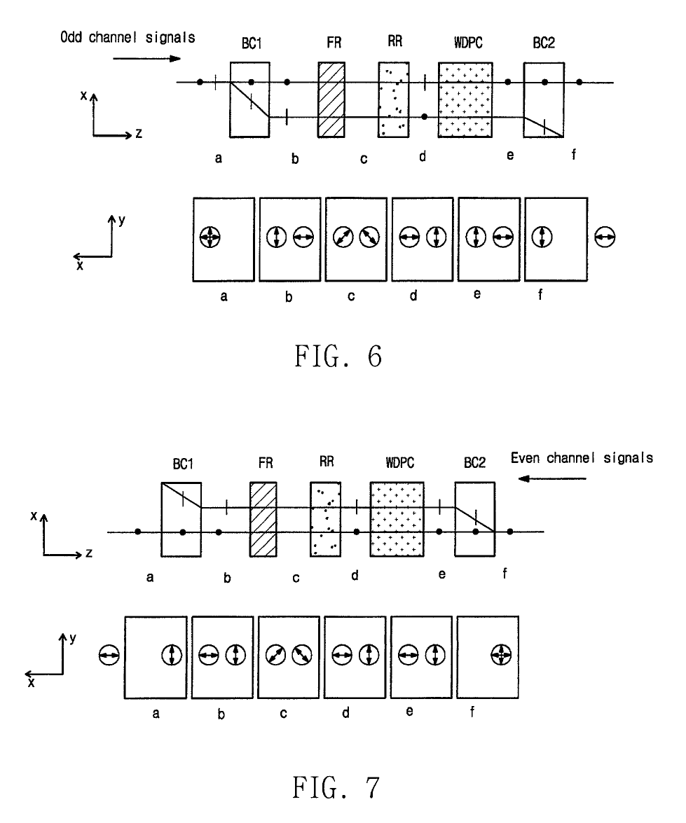

FIG. 6 shows the propagation paths and the polarization states of an attenuated light from Port 1 to Port 2 of FIG. 4. The odd-channel signal is incident to Port 1 of the NRWF. In this case, the paths and the polarization states are same as in the case of FIG. 5 for the BC1, the FR, and the RR. However, the WDPC rotates the polarization state by 90° in the case of odd-channel signal. Two orthogonally polarized lights walk off though BC2 and are not focused on Port 2. Therefore, only the even-channel signal is transmitted from Port 1 to Port 2.

Similarly, FIG. 7/FIG. 8 show the propagation paths and the polarization states of the light from Port 2 to Port 1 of FIG. 4 when the incident light to Port 2 is the even/odd-channel signal. In these cases, the polarization state is not changed by the RR and the FR due to the non-reciprocal property of the FR. Consequently, only the odd-channel signal is transmitted from Port 2 to Port 1, but the even-channel signal is attenuated.

In short, according to the NRWF of the invention, only the even-channel signal is transmitted from Port 1 to Port 2 as shown in FIG. 5 and FIG. 6, and only the odd-channel signal is transmitted from Port 2 to Port 1 as shown in FIG. 7 and FIG. 8.

The NRWF in the invention consists of a WDPC and a polarization independent isolator. Therefore, the NRWF can also be embodied with the WDPCs and the optical isolator.

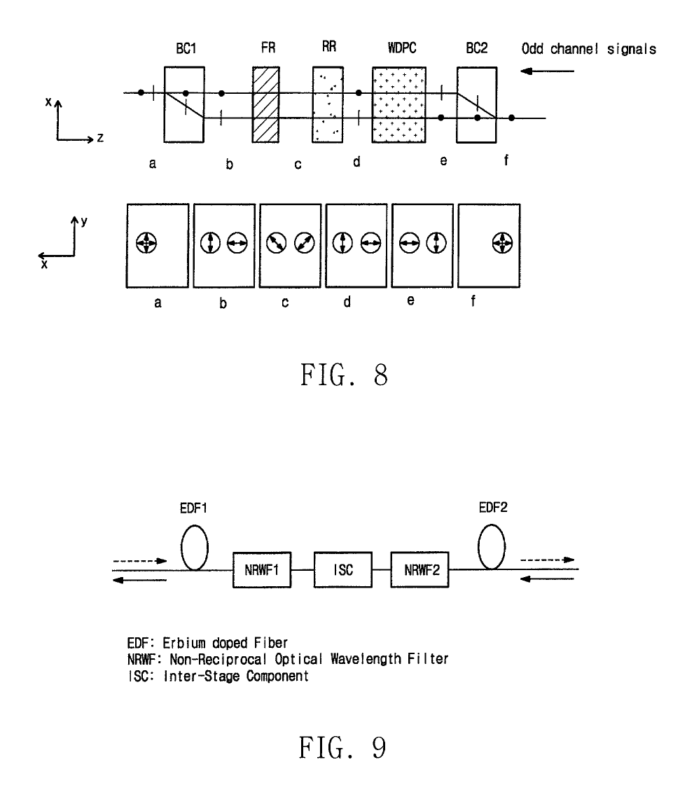

FIG. 9 is a schematic diagram for a bidirectional optical amplifier using the NRWF according to the present invention. The amplifier is composed of Erbium Doped Fibers (EDFs), the NRWFs, and an Inter-Stage Component (ISC). The ISC could be one of a dispersion compensation fiber, a gain flattening filter, and an add-drop module. This configuration of the bidirectional optical amplifier suppresses the reflected light caused by fibers and the ISC. Since the optical signals in both directions share the ISC, the amplifier can reduce the cost.

The NRWF according to the present invention produces the following effects: First, since the transfer characteristics is different according to the propagating direction between the two ports, the NRWF of the invention prevents the degradation of the transmission quality due to multiple reflections in bidirectional transmissions. Second, the NRWF of the invention is suitable for wavelength interleaved bidirectional transmission since the peaks of the transfer spectrum in one propagation direction are located between those of the transfer spectrum in the other propagation direction. Third, the NRWF of the invention could be utilized in bidirectional optical amplifier. The structure of the amplifier with the NRWF of the invention becomes simple and the optical signals in both directions share the ISC. Therefore, economical efficiency is improved.

While the foregoing invention has been described in terms of the embodiments discussed above, numerous variations are possible. Accordingly, modifications and changes such as those suggested above, but not limited thereto, are considered to be within the scope of the following claims.

What is claimed is:

1. An embodying method for a Non-Reciprocal Optical Wavelength Filter (NRWF), as a two-port optical filter with the characteristics of the different transmitting wavelength in each propagating direction, wherein:
the NRWF has periodic transfer characteristics according to the wavelength;
the peaks of the transfer spectrum from Port 1 to Port 2 are located between those of the transfer spectrum from Port 2 to Port;
if the transmitted light from Port 1 to Port 2 is reflected by fibers and optical devices, the reflected light is attenuated as it propagates from Port 2 to Port 1; and
if the transmitted light from Port 2 to Port 1 is reflected, the reflected wave is attenuated as it propagates from Port 1 to Port 2.

2. An apparatus for a Non-Reciprocal Optical Wavelength Filter (NRWF), as a two-port filter with different transfer spectrum in each propagating direction, having periodic transfer characteristics, and comprising:
a reciprocal polarization rotation means (RR) rotating the polarization state of light reciprocally,;
a non-reciprocal polarization rotation means (FR) rotating the polarization state of light non-reciprocally according to the propagating direction;
first and second polarization splitting/combining means (BC1, BC2) splitting unpolarized light into two orthogonally polarized lights, or combining two orthogonally polarized lights; and
a wavelength-dependent polarization converting means (WDPC) changing the polarization state according to the wavelength.

3. An apparatus as defined in claim 2 wherein the wavelength-dependent polarization converting means uses an anisotropic crystal.

4. An apparatus as defined in claim 3 wherein the incident light is linearly polarized, and the incident angle to the wavelength-dependent polarization converting means is 45° with respect to the crystal axis.

5. An apparatus as defined in claim 3 wherein the wavelength-dependent polarization converting means periodically changes the polarization state of according to the wavelength of incident light; and the transmitted wavelengths are determined by birefringence and the length of the anisotropic crystal.

6. An apparatus as defined in claim 2 wherein the NRWF comprises:
polarization splitting/combining means splitting an unpolarized light into two orthogonally polarized lights, or combining the two orthogonally polarized lights;
first polarization rotation means rotating the polarization state non-reciprocally according to the propagating direction;
second polarization rotation means rotating the polarization state of the light reciprocally; and
third polarization rotation means changing the polarization state according to the wavelength of light.

7. An apparatus as defined in claim 2 wherein: the order of the parts is:
the first polarization splitting/combining means;
the non-reciprocal polarization rotation means;
the reciprocal polarization rotation means;
the wavelength-dependent polarization converting means; and
the second polarization splitting/combining means; and
the front of the first polarization splitting/combining means; and
the back of the second polarization splitting/combining means are connected to the optical fiber through lenses.

8. An apparatus as defined in claim 2 wherein the NRWF is a multiple-reflection suppresser in bidirectional optical transmissions.

9. An apparatus as defined in claim 2 wherein the NRWF is used in bidirectional optical amplifiers.

10. An apparatus as defined in claim 9 wherein the NRWF is located between two Erbium Doped Fibers, or it is located at both ends of an Inter-Stage Component (ISC) placed between two Erbium Doped Fibers.

11. An apparatus as defined in claim 10 wherein the ISC is one of a dispersion compensation fiber, a gain flattening filter, or an add-drop module.
